(19) United States
(12) Patent Application Publication
(10) Pub. No.: US 2010/0332832 A1
(43) Pub. Date: Dec. 30, 2010

(54) TWO-FACTOR AUTHENTICATION METHOD AND SYSTEM FOR SECURING ONLINE TRANSACTIONS

(75) Inventors: Jui-Ming WU, Yonghe City (TW); Jia-Jum Hung, Changhua City (TW); Chia-Ta Lin, Taipei City (TW); Hsin-Yi Lai, Taipei City (TW)

Correspondence Address: BIRCH STEWART KOLASCH & BIRCH, PO BOX 747, FALLS CHURCH, VA, 22040-0747, US

(73) Assignee: Institute for Information Industry, Taipei (TW)

(21) Appl. No.: 12/568,511

(22) Filed: Sep. 28, 2009

(30) Foreign Application Priority Data
Jun. 26, 2009 (TW) 09821560

(51) Int. Cl. H04L 9/32

(52) U.S. Cl. 713/169

(57) ABSTRACT

A two-factor authentication system is provided for securing online transactions. In the two-factor authentication system, a transaction server provides online transaction services. A mobile communication device receives short messages. A client computing device applies a first authentication function to communicate with the transaction server, receives, via short messages, a first authentication code used to authenticate the transaction server, and applies a second authentication function to generate a second authentication code. Next, the transaction server authenticates the client computing device with the second authentication function and second authentication code.

### CROSS REFERENCE TO RELATED APPLICATIONS

This Application claims priority of Taiwan Patent Application No. 98121560, filed on Jun. 22, 2009, the entirety of which is incorporated by reference herein.

### BACKGROUND OF THE INVENTION

1. Field of the Invention

The invention generally relates to authentication technologies, and more particularly, to a two-factor authentication method and system for securing online transactions.

2. Description of the Related Art

As the popularity of the internet and its related applications grows, many conventional consumer activities involving monetary transactions are being conducted through the internet. For example, through online transactions (which include, browsing items, placing an order, and receiving items by delivery), consumers can complete purchases without physically going to the place of purchase. Thus, due to convenience, online transactions have rapidly increased. However, private information safety is always a concern, as during transactions, consumers are often required to submit their credit card or automatic teller machine (ATM) card information. Thus, secure authentication methods are critical for online transactions. Meanwhile, additional types of online transactions include internet banking, buying and selling of stock, and citizen digital certificate (CDC)-related application transactions.

Conventionally, two secure authentication methods are mainly used today. The first method is based on a fixed password for user identifications (IDs). The disadvantage of this method is that computer hackers may intercept the information, when being imputed, for abuse. The second method is based on a one-time password (OTP) for user identifications (IDs). The advantage of this method is that while computer hackers may intercept the information, when being imputed, the password information would be invalid for following use, thus, preventing abuse. Depending upon collocating hardware, the second method can be further divided into the following 3 types:

(1) External hand-held hardware for generating dynamic passwords: The hardware may be a dynamic password generator, or an ATM card with a card reader. The disadvantage for users of this type of method includes additional costs to purchase required hardware and inconvenience in requiring the hardware to be carried for usage.

(2) Mobile phone capable of dynamic password calculation: The advantage of this method over the first method is that no additional hardware is required to be carried for usage, as a user's mobile phone may contain the dynamic password calculation function. However, availability of mobile phones with dynamic password calculation functions is limited and dynamic password calculation functions in mobile phones, increase the cost of the mobile phones.

(3) Mobile phone supporting Short Message Services (SMSs): The advantage of this method over the first method is that no additional hardware is required to be carried for usage, as service providers generate and transmit dynamic passwords to users. However, the disadvantage of this method is that security level of SMSs is low. Additionally, since the dynamic passwords are mobile phone-based, any user of the mobile phone may obtain the dynamic password, even those of a stolen mobile phone.

### BRIEF SUMMARY OF THE INVENTION

Accordingly, embodiments of the invention provide an apparatus, system, and methods for handling attach procedures in a mobile communication system environment. In one aspect of the invention, a two-factor authentication system for securing online transactions is provided. The two-factor authentication system comprises a transaction server, a client computer, and a mobile communication device. The transaction server provides online transaction services, and further receives a transaction request from the client computer via an internet connection. Additionally, the transaction server applies a first authentication function to generate a first authentication code, encrypts the first authentication code and transmits the encrypted first authentication code in at least one of the short messages to the mobile communication device. Moreover, the transaction server authenticates the client computer with a second authentication function, a second authentication code, and a user password. The client computer decrypts the encrypted first authentication code to obtain the first authentication code, authenticates the transaction server with the first authentication function, the first authentication code, and the user password, applies the second authentication function to generate the second authentication code, and transmits the second authentication code to the transaction server via the internet connection. The mobile communication device is used to receive short messages.

In another aspect of the invention, a two-factor authentication method for securing online transactions between a client computer and a transaction server connected via an internet connection is provided. The two-factor authentication method comprises: transmitting, performed by the client computer, a transaction request to the transaction server via the internet connection; applying, performed by the transaction server, a first authentication function to generate a first authentication code; encrypting, performed by the transaction server, the first authentication code and transmitting the encrypted first authentication code in at least one short message to a mobile communication device; decrypting, performed by the client computer, the encrypted first authentication code to obtain the first authentication code; authenticating, performed by the client computer, the transaction server with the first authentication function, the first authentication code, and a user password; applying, performed by the client computer, a second authentication function to generate a second authentication code and transmitting the second authentication code to the transaction server via the internet connection; and authenticating, performed by the transaction server, the client computer with the second authentication function, the second authentication code, and the user password.

Other aspects and features of the present invention will become apparent to those ordinarily skilled in the art upon review of the following descriptions of specific embodiments of the two-factor authentication system and method for securing online transactions.

### BRIEF DESCRIPTION OF DRAWINGS

The invention can be more fully understood by reading the subsequent detailed description and examples with references made to the accompanying drawings, wherein:

FIG. 1 is a diagram illustrating a two-factor authentication system for securing online transactions in accordance of an embodiment of this present invention;

FIG. 2 is a message sequence chart illustrating the two-factor authentication method for securing online transactions according to an embodiment of the invention;

FIG. 3 is a flow chart illustrating the two-factor authentication method for securing online transactions according to an embodiment of the invention;

FIGS. 4A and 4B are message sequence charts illustrating the two-factor authentication method using the Diffi-Hellman protocol according to an embodiment of the invention;

FIGS. 5A and 5B are message sequence charts illustrating the two-factor authentication method using the general SSL-like protocol according to an embodiment of the invention;

FIGS. 6A and 6B are message sequence charts illustrating the two-factor authentication method using the SSL-like protocol with the RSA algorithm according to an embodiment of the invention; and

FIGS. 7A and 7B are message sequence charts illustrating the two-factor authentication method using the SSL-like protocol with the Diffi-Hellman algorithm according to an embodiment of the invention.

### DETAILED DESCRIPTION OF THE INVENTION

The following description is made for the purpose of illustrating the general principles, characteristics, and advantages of the invention, with preferred embodiments and accompanying drawings.

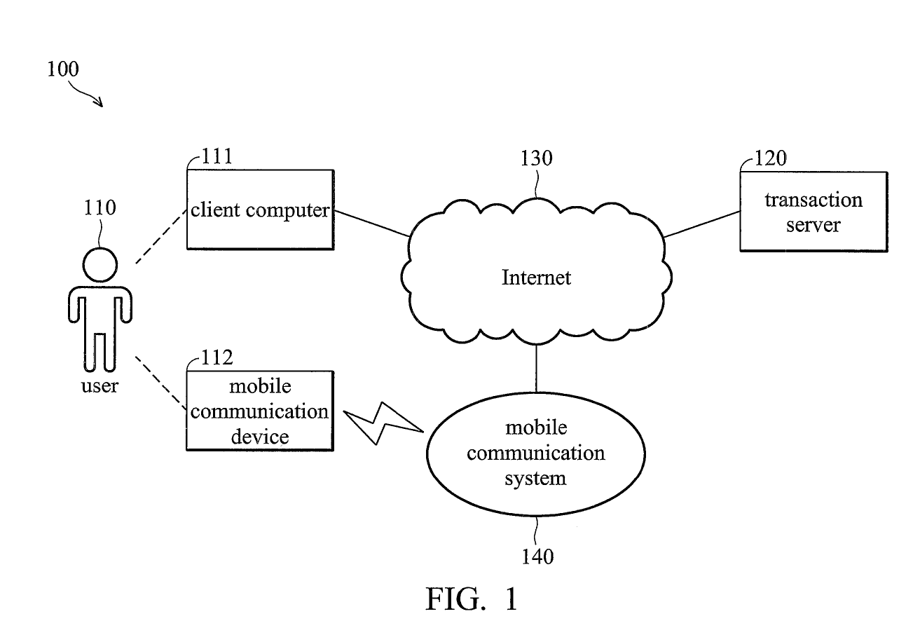

FIG. 1 is a diagram illustrating a two-factor authentication system for securing online transactions in accordance of an embodiment of this present invention. The two-factor authentication system 100 includes a client computer 111 used by a user 110, a mobile communication device 112, and a transaction server 120. The client computer 111 and transaction server 120 both connect to the Internet 130, and communicate online transaction information with each other via the Internet 130. The mobile communication device 112 connects to a mobile communication system 140 through the air interface, and the mobile communication system 140 further connects to the Internet 130. Thus, computers connecting to the Internet 130 and having the SIM card number of the mobile communication device 112 can transmit short messages to the mobile communication device 112.

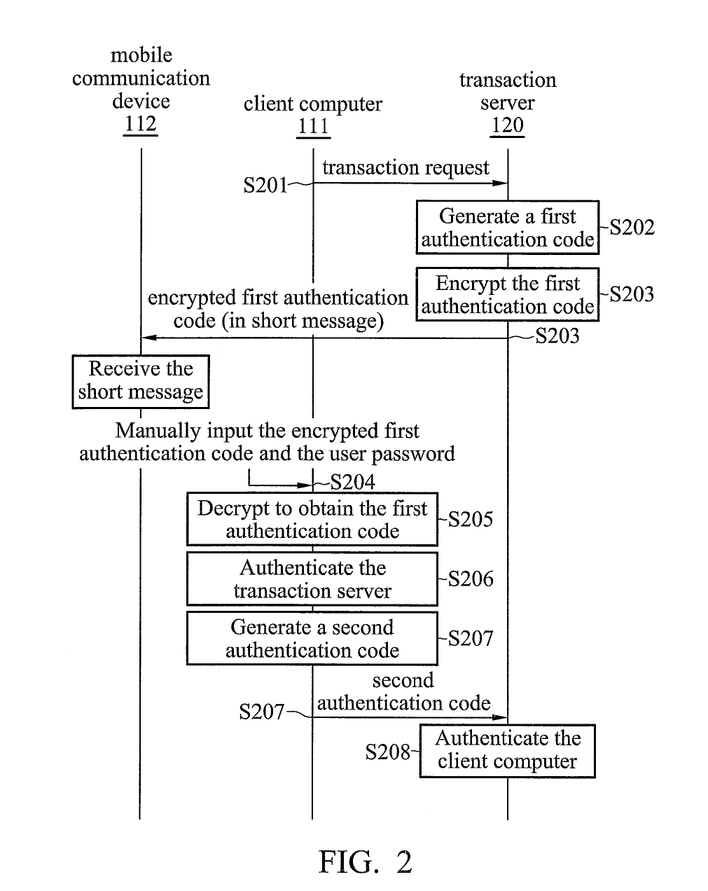

FIG. 2 is a message sequence chart illustrating the two-factor authentication method for securing online transactions according to an embodiment of the invention. The operation of the two-factor authentication method shown in FIG. 2 complies with the system architecture in FIG. 1. Generally, before an online transaction takes place, the user 110 uses the client computer 111 to connect to the transaction server 120, and browses the online transaction web page provided by the transaction server 120. The user 110 registers a user identification and a user password with the transaction server 120. If required by the transaction server 120, the user 110 also inputs an SIM card number, i.e. the phone number, of the mobile communication device 112 during the registration process.

As shown in FIG. 2, when the user 110 wishes to conduct an online transaction, he or she operates the client computer 111 to transmit a transaction request to the transaction server 120 (step S201). After receiving the transaction request, the transaction server 120 applies a first authentication function to generate a first authentication code (step S202). The transaction server 120 further encrypts the first authentication code and transmits the encrypted first authentication code in at least one short message to the mobile communication device 112 (step S203). The user 110 retrieves the encrypted first authentication code from the short message and inputs it together with the user password in the client computer 111 (step S204). The client computer 111 decrypts the encrypted first authentication code to obtain the first authentication code (step S205). Next, for validating the transaction server 120, the client computer 111 authenticates the transaction server 120 with the first authentication function, the first authentication code, and the user password (step S206). If the authentication of the transaction server 120 is successful, the client computer 111 applies a second authentication function to generate a second authentication code and the client computer 111 transmits the second authentication code to the transaction server 120 (step S207). After receiving the second authentication code, the transaction server 120 authenticates the client computer 111 with the second authentication function, the second authentication code, and the user password, to see if the client computer 111 is valid (step S208).

In the two-factor authentication method, for encrypting and decrypting of the first authentication code, a session key, generated by a session key negotiation procedure between the client computer 111 and the transaction server 120, may be used. The session key negotiation procedure may comply with the Diffi-Hellman protocol, the SSL(Secure Sockets Layer)-like protocol, or key distribution protocol. The SSL-like protocol includes the general Secure Sockets Layer protocol, the Secure Sockets Layer protocol with the RSA algorithm, and the Secure Sockets Layer protocol with the Diffi-Hellman algorithm. Moreover, the session key negotiations procedure may be performed to generate one session key for each online transaction, or performed only once to generate one session key for multiple online transactions. Generation of the session key is dependent upon security requirements and costs, with generation of one session key for each online transaction being more secure with higher costs than generation of one session key for multiple online transactions.

The two-factor authentication method as described above uses the mobile communication device 112 to receive the short message with the encrypted first authentication code (factor 1), and further uses the user password (factor 2), which is registered to the transaction server 120 before the online transaction takes place. These two factors prevent the present invention from being cracked due to a stolen SIM card or a stolen user password, because one has to obtain both the user password and the short message, through the SIM card, with the encrypted first authentication code to pass the authentication. Hence, the two-factor authentication method achieves better security level than the conventional authentication method. Additionally, in order to simplify manual input of the short message(s) in the client computer 111, in other embodiments of the invention, the encrypted first authentication code may be divided into 2 portions. The first portion is transmitted in short message(s) to the mobile communication device 112, and the second portion is transmitted to the client computer 111 via the Internet 130. When the user 110 inputs the first portion in the client computer 111, the client computer 111 combines the first portion and the second portion to obtain the complete encrypted first authentication code and proceeds with the following authentication process.

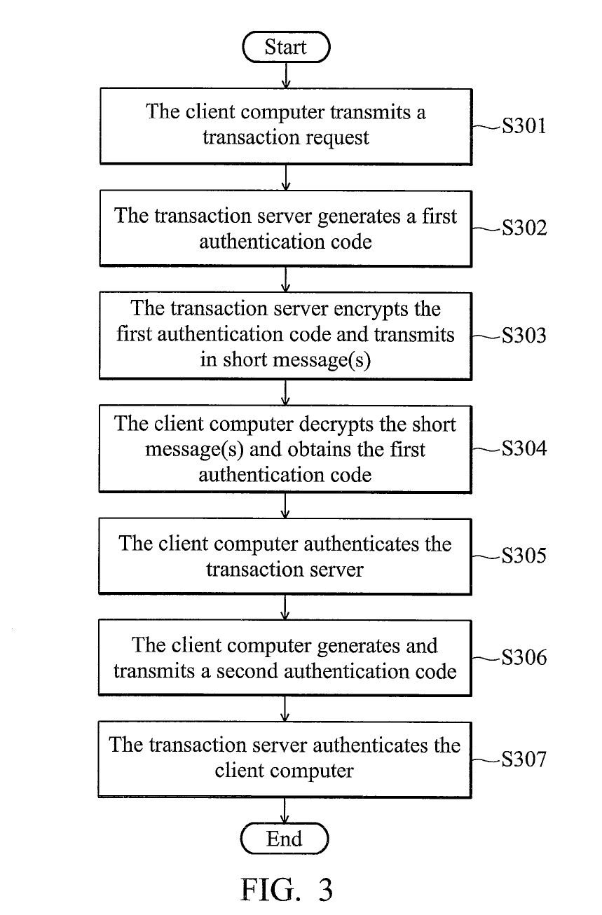

FIG. 3 is a flow chart illustrating the two-factor authentication method for securing online transactions according to an embodiment of the invention. Initially, when the user 110 wishes to conduct an online transaction, he or she operates the client computer 111 to transmit a transaction request to the transaction server 120 (step S301). After receiving the transaction request, the transaction server 120 applies a first authentication function to generate a first authentication code (step S302). The transaction server 120 further encrypts the first authentication code and transmits the encrypted first authentication code in at least one short message to the mobile communication device 112 (step S303). When the short message(s) is received in the mobile communication device 112, the user 110 retrieves the encrypted first authentication code from the short message and inputs it together with the user password in the client computer 111. The client computer 111 decrypts the encrypted first authentication code to obtain the first authentication code (step S304). Next, for validating the transaction server 120, the client computer 111 authenticates the transaction server 120 with the first authentication function, the first authentication code, and the user password (step S305). If the authentication of the transaction server 120 is successful, the client computer 111 applies a second authentication function to generate a second authentication code and the client computer 111 transmits the second authentication code to the transaction server 120 (step S306). After receiving the second authentication code, the transaction server 120 authenticates the client computer 111 with the second authentication function, the second authentication code, and the user password, to see if the client computer 111 is valid (step S307), wherein, the method ends.

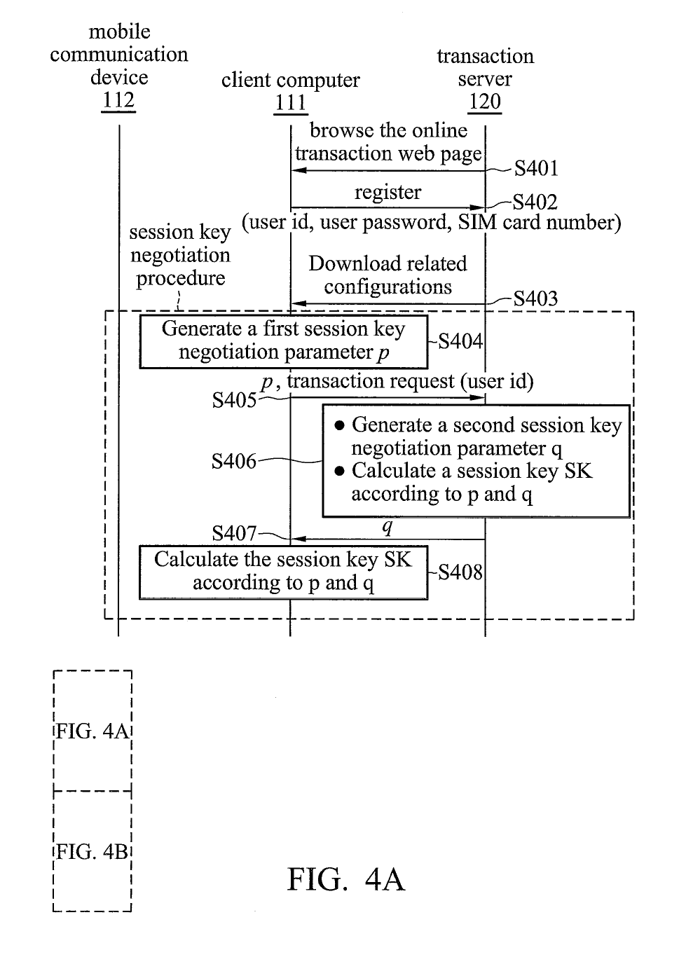

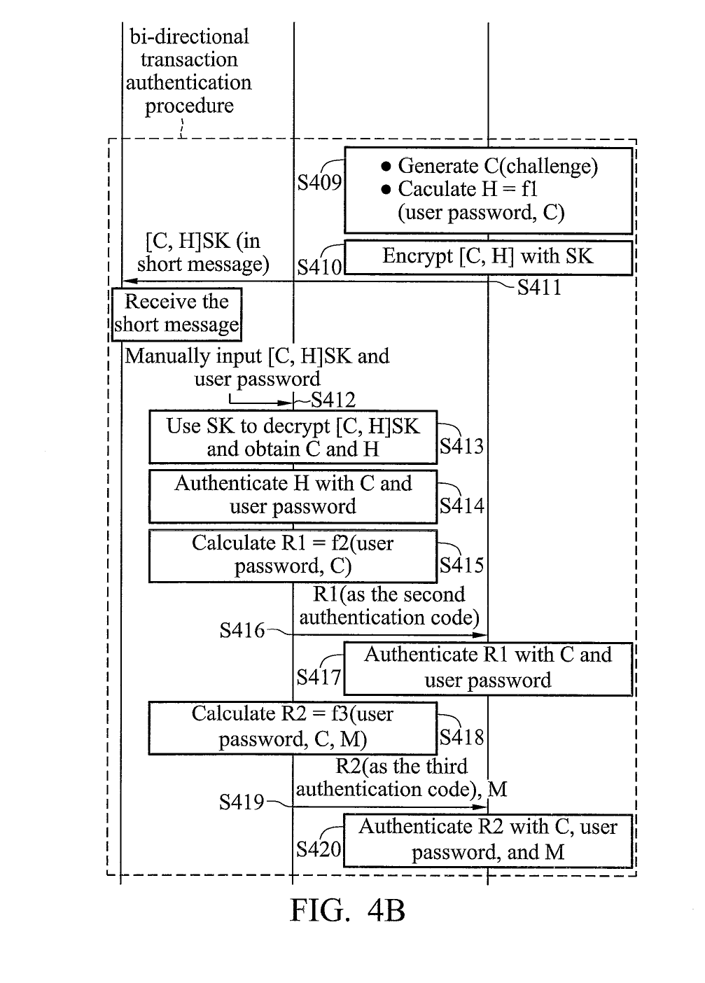

FIGS. 4A and 4B are message sequence charts illustrating the two-factor authentication method using the Diffi-Hellman protocol according to an embodiment of the invention. As shown in FIG. 4A, before an online transaction takes place, the user 110 uses the client computer 111 to connect to the transaction server 120, and browses the online transaction web page provided by the transaction server 120 (step S401). The user 110 registers a user identification, a user password, and the SIM card number of the mobile communication device 112 with the transaction server 120 (step S402). On the online transaction web page, the transaction server 120 prompts the user 110 to download related configurations of the online transaction process (step S403), including the session key negotiation protocol, and the first, second, and third authentication function. Steps S402 and S403 may be performed before the online transaction takes place, i.e. before step S401. In this embodiment, the session key negotiation procedure uses the Diffi-Hellman protocol.

Subsequently, when the user 110 wishes to conduct an online transaction, he or she operates the client computer 111 to perform the session key negotiation procedure using the Diffi-Hellman protocol. At first, the client computer 111 generates a first session key negotiation parameter p (step S404), and transmits the first session key negotiation parameter p and a transaction request to the transaction server 120 (step S405). The transaction request includes the user identification of the user 110. After receiving the transaction request, the transaction server 120 uses the Diffi-Hellman protocol to generate a second session key negotiation parameter q, and calculates a session key SK according to p and q (step S406). Then, the transaction server 120 transmits the second session key negotiation parameter q to the client computer 111 (step S407). Accordingly, the client computer 111 also calculates the session key SK according to p and q (step S408).

As shown in FIG. 4B, when the session key negotiation procedure ends, the two-factor authentication method proceeds with a bi-directional transaction authentication procedure. Firstly, the bi-directional transaction authentication procedure starts with the client computer 111 validating the transaction server 120. The transaction server 120 generates a challenge parameter C of the first authentication function, and then applies the challenge parameter C and the user password to the first authentication function fl to calculate a hash value H (step S409). The transaction server 120 uses the combination of the challenge parameter C and the hash value H as a first authentication code, and encrypts the first authentication code with the session key SK (step S410). Then, the transaction server 120 transmits the encrypted first authentication code in a short message(s) to the mobile communication device 112 (step S411). When the user 110 confirms the reception of the short message(s) in the mobile communication device 112, the user 110 operates the client computer 111 to input the context of the short message(s) and the user password in the online transaction web page provided by the transaction server 120 (step S412). Next, the client computer 111 uses the session key CK to decrypt the context of the short message(s) to obtain the first authentication code (step S413), and applies the challenge parameter C and the user password of the first authentication code in the first authentication function fl, to validate if the calculated hash value equals to the hash value H in the first authentication code (step S414). If yes, the transaction server 120 is validated; otherwise, the transaction server 120 is not validated, and the client computer 111 shows a message, “Transaction server has failed to pass the authentication test!”, in a window interface to notify the user 110 and the online transaction is terminated.

Secondly, the bi-directional transaction authentication procedure proceeds with the transaction server 120 validating the client computer 111. The client computer 111 applies the challenge parameter C and the user password in the second authentication function f2 to calculate another hash value R1 (step S415). The client computer 111 uses the hash value R1 as a second authentication code, and transmits the second authentication code to the transaction server 120 (step S416). Subsequently, the transaction server 120 applies the challenge parameter C and the user password in the second authentication function f2 to validate if the calculated hash value equals to the hash value R1 in the second authentication code (step S417). If yes, the client computer 111 is validated; otherwise, the client computer 111 is not validated, and the transaction server 120 may respond to the client computer 111 with a transaction failure message so that the client computer 111 may resend the transaction request.

In addition to the bi-directional authentication procedure as described above (authenticating the transaction server and the client computer), the present invention also provides authentication of the transaction messages to make sure the transaction messages are secured. The authentication of the transaction messages is as follows. After step S417, the client computer 111 applies the challenge parameter C, the user password, and the transaction message M in the third authentication function f3 to calculate a hash value R2 (step S418). The client computer 111 uses the hash value R2 as the third authentication code and transmits the third authentication code to the transaction server 120 (step S419). Next, the transaction server 120 applies the challenge parameter C, the user password, and the transaction message M of the third authentication code in the third authentication function f3 to validate if the calculated hash value equals to the hash value R2 in the third authentication code (step S420).

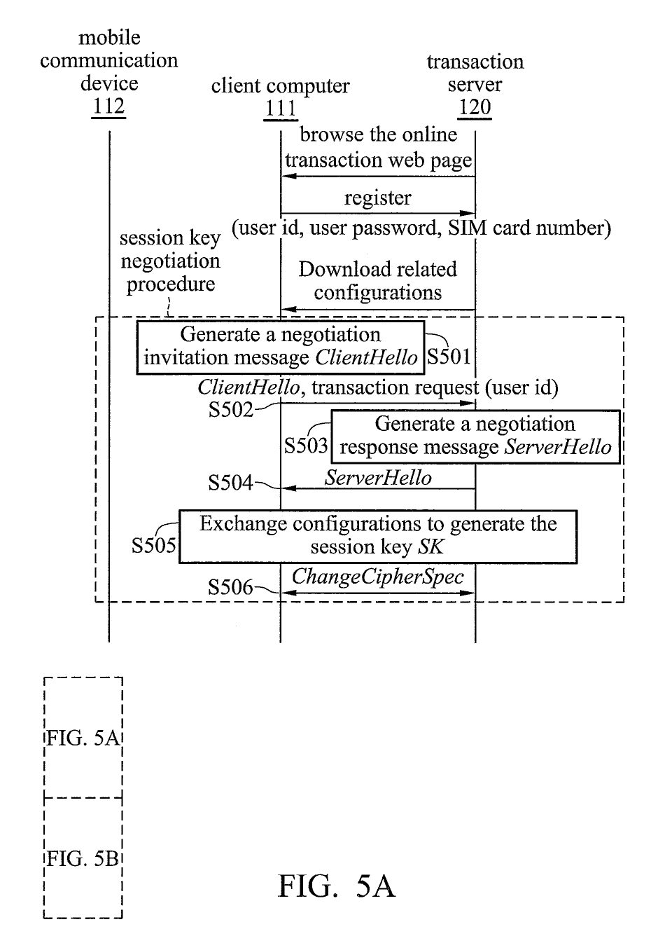

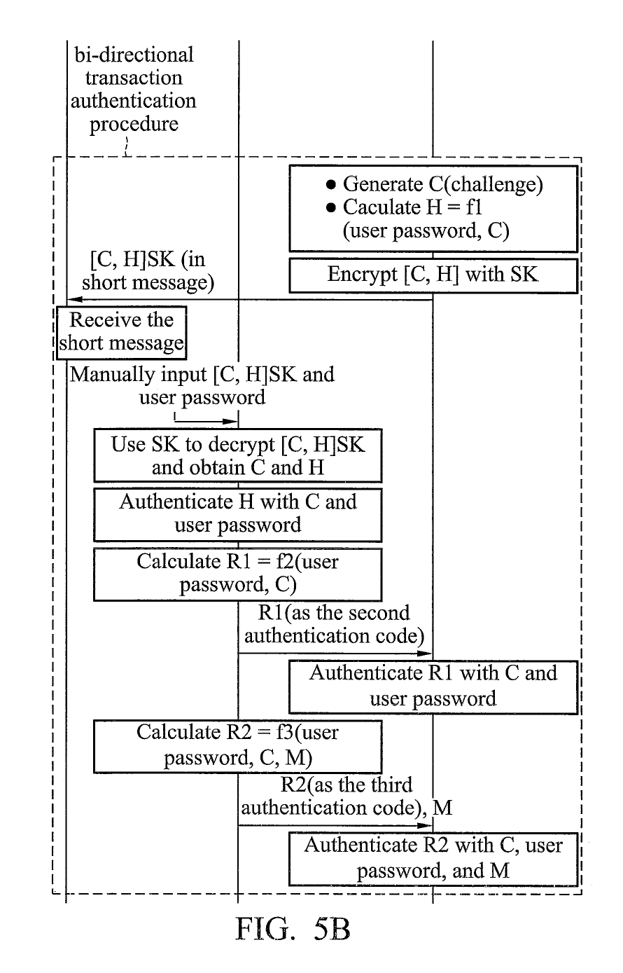

FIGS. 5A and 5B are message sequence charts illustrating the two-factor authentication method using the general SSL-like protocol according to an embodiment of the invention. In this embodiment, the user 110 first uses the client computer 111 to connect to the transaction server 120, and browses the online transaction web page provided by the transaction server 120. The user 110 registers a user identification, a user password, and the SIM card number of the mobile communication device 112 with the transaction server 120 through the online transaction web page. Next, the transaction server 120 prompts the user 110 to download related configurations of the following online transaction process, including the session key negotiation protocol, the first, second, and third authentication function. The steps described so far is the same as steps S401˜S403 in FIG. 4A, and steps S402 and S403 may be performed before the online transaction takes place, i.e. before step S401.

Subsequently, as shown in FIG. 5A, when the user 110 wishes to conduct an online transaction, he or she operates the client computer 111 to perform the session key negotiation procedure using the general SSL-like protocol. At first, the client computer 111 generates a negotiation invitation message ClientHello (step S501), and transmits the negotiation invitation message ClientHello and a transaction request to the transaction server 120 (step S502). The negotiation invitation message ClientHello includes the versions of the SSL protocol, the cipher suites, and the compression methods that the client computer 111 supports. The transaction request includes the user identification of the user 110. After receiving the negotiation invitation message ClientHello, the transaction server 120 uses the general SSL-like protocol to generate a negotiation response message ServerHello (step S503), and transmits the negotiation response message ServerHello to the client computer 111 (step S504). After receiving the negotiation response message ServerHello, the client computer 111 and the transaction server 120 exchange configurations related to the session key, and accordingly generate the session key SK (step S505) Next, the client computer 111 and the transaction server 120 jointly use the message ChangeCipherSpec to inform each other about the information of cipher specification changes to complete the configurations of the session key negotiation (step S506). As shown in FIG. 5B, when the session key negotiation procedure ends, the two-factor authentication method proceeds with the bi-directional transaction authentication procedure (the client computer 111 authenticating the transaction server 120, and vice versa) and the following online transaction message exchanges, as described in steps S409˜S420 of FIG. 4B.

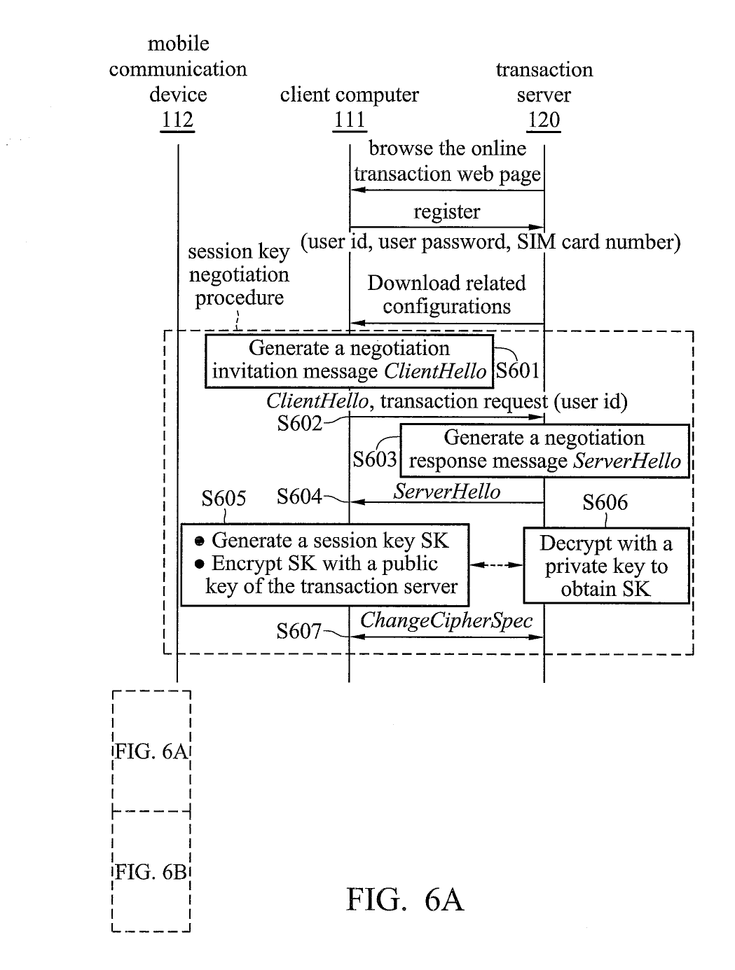

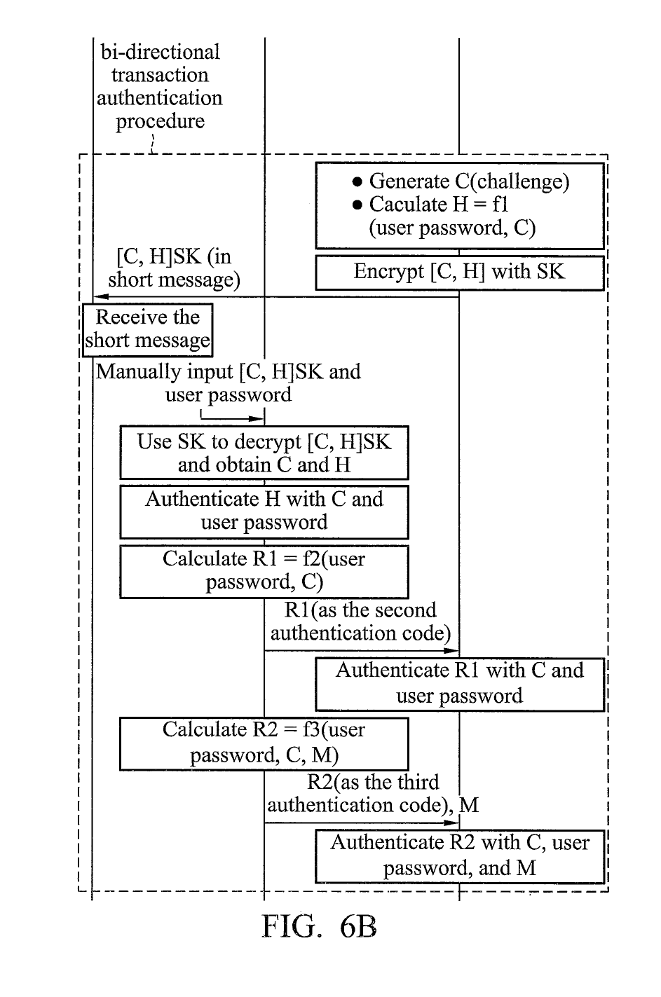

FIGS. 6A and 6B are message sequence charts illustrating the two-factor authentication method using the SSL-like protocol with the RSA algorithm according to an embodiment of the invention. In this embodiment, the user 110 uses the client computer 111 to connect to the transaction server 120 to browse the online transaction web page provided by the transaction server 120, register a user identification, a user password, and the SIM card number of the mobile communication device 112 with the transaction server 120, and download related configurations of the online transaction process, including the session key negotiation protocol, the first, second, and third authentication function. The steps described so far are the same as steps S401˜S403 in FIG. 4A, and steps S402 and S403 may be performed before the online transaction takes place, i.e. before step S401.

Subsequently, as shown in FIG. 6A, when the user 110 wishes to conduct an online transaction, he or she operates the client computer 111 to perform the session key negotiation procedure using the SSL-like protocol with the RSA algorithm. At first, the client computer 111 generates a negotiation invitation message ClientHello (step S601), and transmits the negotiation invitation message ClientHello and a transaction request to the transaction server 120 (step S602). The negotiation invitation message ClientHello includes the versions of the SSL protocol, the cipher suites, and the compression methods that the client computer 111 supports. The transaction request includes the user identification of the user 110. After receiving the negotiation invitation message ClientHello, the transaction server 120 uses the SSL-like protocol to generate a negotiation response message ServerHello (step S603), and transmits the negotiation response message ServerHello to the client computer 111 (step S604). After receiving the negotiation response message ServerHello, the client computer 111 generates the session key SK, and encrypts the session key SK with the public key of the transaction server 120 (step S605). The client computer 111 then transmits the encrypted session key to the transaction server 120. Upon receiving the encrypted session key, the transaction server 120 uses its private key to decrypt the encrypted session key and obtain the session key SK (step S606). Next, the client computer 111 and the transaction server 120 jointly use the message ChangeCipherSpec to inform each other about the information of cipher specification changes and the configurations of the session key negotiation is completed (step S607). As shown in FIG. 6B, when the session key negotiation procedure ends, the two-factor authentication method proceeds with the bi-directional transaction authentication procedure (the client computer 111 authenticating the transaction server 120, and vice versa) and the following online transaction message exchanges, as described in steps S409˜S420 of FIG. 4B.

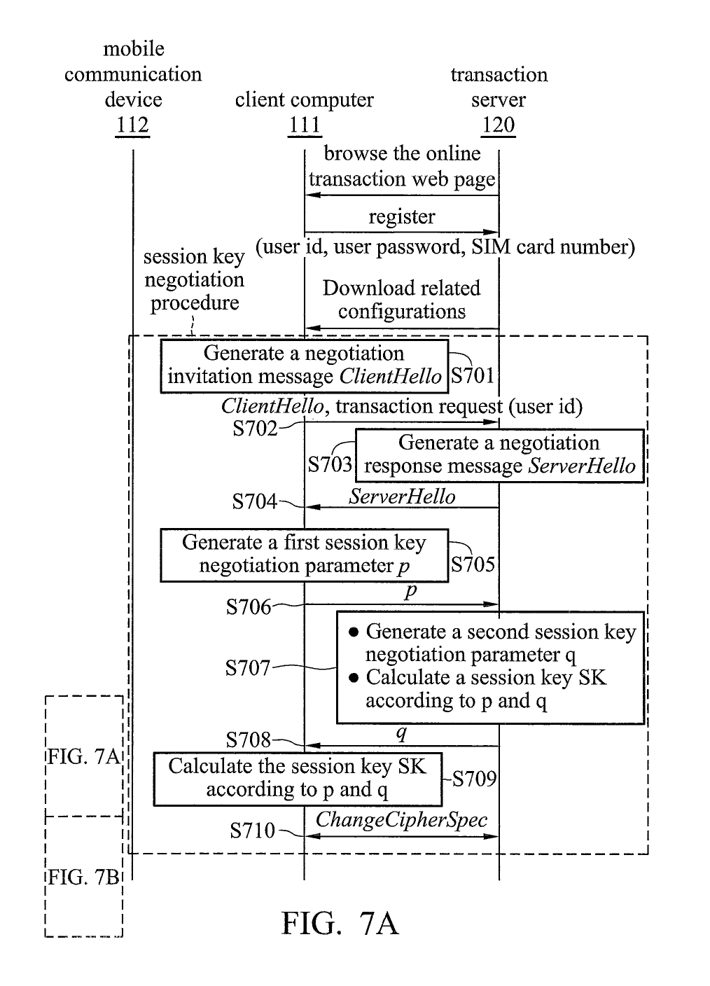

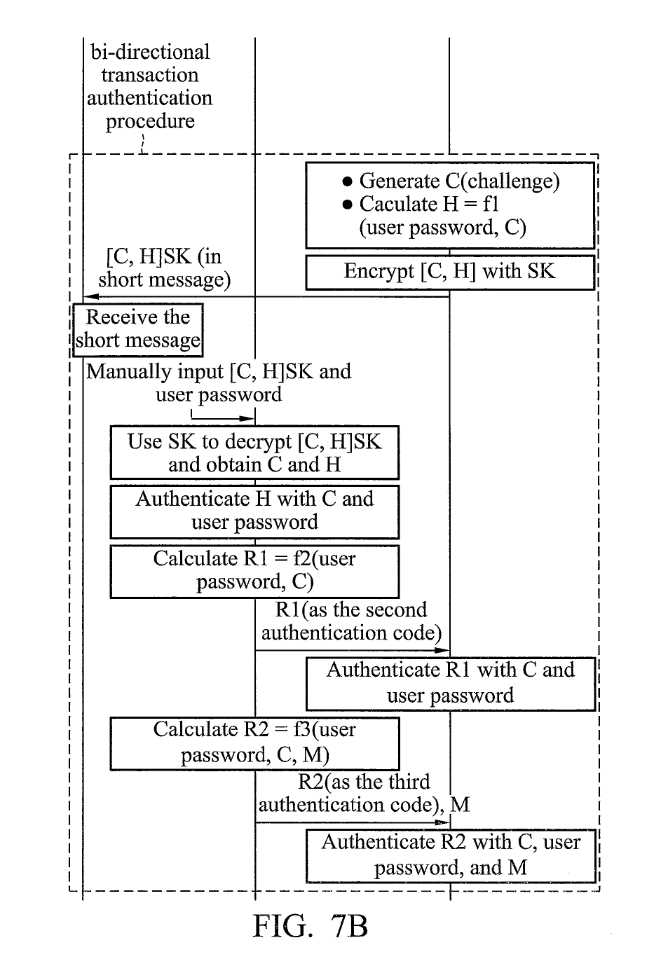

FIGS. 7A and 7B are message sequence charts illustrating the two-factor authentication method using the SSL-like protocol with the Diffi-Hellman algorithm according to an embodiment of the invention. In this embodiment, the user 110 uses the client computer 111 to connect to the transaction server 120 to browse the online transaction web page provided by the transaction server 120, register a user identification, a user password, and the SIM card number of the mobile communication device 112 with the transaction server 120, and download related configurations of the following online transaction processes, including the session key negotiation protocol, the first, second, and third authentication function. The steps described so far are the same as steps S401˜S403 in FIG. 4A, and steps S402 and S403 may be performed before the online transaction takes place, i.e. before step S401.

Subsequently, as shown in FIG. 7A, when the user 110 wishes to conduct an online transaction, he or she operates the client computer 111 to perform the session key negotiation procedure using the SSL-like protocol with the Diffi-Hellman algorithm. At first, the client computer 111 generates a negotiation invitation message ClientHello (step S701), and transmits the negotiation invitation message ClientHello and a transaction request to the transaction server 120 (step S702). The negotiation invitation message ClientHello includes the versions of the SSL protocol, the cipher suites, and the compression methods that the client computer 111 supports. The transaction request includes the user identification of the user 110. After receiving the negotiation invitation message ClientHello, the transaction server 120 uses the SSL-like protocol to generate a negotiation response message ServerHello (step S703), and transmits the negotiation response message ServerHello to the client computer 111 (step S704). After receiving the negotiation response message ServerHello, the client computer 111 uses the Diffi-Hellman algorithm to generate a first session key negotiation parameter p (step S705) and transmits the to the transaction server 120 (step S706). The transaction server 120 further uses the Diffi-Hellman algorithm to generate a second session key negotiation parameter q and calculates the session key SK according to the first session key negotiation parameter p and the second session key negotiation parameter q (step S707). The transaction server 120 then transmits the second session key negotiation parameter q to the client computer 111 (step S708). Next, the client computer 111 also calculates the session key SK according to the first session key negotiation parameter p and the second session key negotiation parameter q (step S709). At last, the client computer 111 and the transaction server 120 jointly use the message ChangeCipherSpec to inform each other about the information of cipher specification changes and the configurations of the session key negotiation is completed (step S710). After the session key negotiation procedure ends, and as shown in FIG. 7B, the two-factor authentication method proceeds with the bi-directional transaction authentication procedure (the client computer 111 authenticating the transaction server 120, and vice versa) and the following online transaction message exchanges, as described in steps S409˜S420 of FIG. 4B.

Although the registration processes of the two-factor authentication methods in FIGS. 4A/B-7A/B are operated through the internet, a user, in other embodiments, can personally fill in a registration form at the server counter of the online transaction company, to complete the registration process by writing the user identification, the user password, the SIM card number of the mobile communication device 112, and other user information in the registration form. The online transaction company then inputs the user information in the registration form into the transaction server 120. Alternatively, the input user information may be stored in a storage device connected to the transaction server 120 via an internet connection, and the transaction server 120 may access the user information via the internet connection.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A two-factor authentication system for securing online transactions, comprising:
a transaction server, providing online transaction services;
a client computer, providing a second authentication code; and
a mobile communication device, receiving short messages,
wherein the transaction server is further configured to perform:
receiving a transaction request from the client computer via an internet connection,
applying a first authentication function to generate a first authentication code,
encrypting the first authentication code and transmitting the encrypted first authentication code in at least one of the short messages to the mobile communication device, and
authenticating the client computer with a second authentication function, the second authentication code, and a user password, and
the client computer is further configured to perform:
decrypting the encrypted first authentication code to obtain the first authentication code,
authenticating the transaction server with the first authentication function, the first authentication code, and the user password,
applying the second authentication function to generate the second authentication code, and
transmitting the second authentication code to the transaction server via the internet connection.

2. The two-factor authentication system of claim 1, wherein the client computer further applies a third authentication function to a transaction message to generate a third authentication code and transmits the transaction message and the third authentication code to the transaction server via the internet connection, and the transaction server authenticates the client computer with the third authentication function, the third authentication code, and the user password.

3. The two-factor authentication system of claim 1, wherein before transmitting the transaction request, the client computer registers a user identification, the user password, and a SIM card number of the mobile communication device to the transaction server, and the transaction request comprises the user identification.

4. The two-factor authentication system of claim 3, wherein the transaction server transmits a confirmation code in at least one of the short messages to the mobile communication device upon being registered to by the client computer, and the client computer responds, with the confirmation code, to the transaction server to confirm the SIM card number.

5. The two-factor authentication system of claim 1, wherein the transaction server and the client computer perform a session key negotiation procedure via the internet connection to generate a shared session key for encrypting and decrypting the first authentication code.

6. The two-factor authentication system of claim 5, wherein the session key negotiation procedure is performed according to a Diffi-Hellman protocol or an SSL-like protocol.

7. The two-factor authentication system of claim 1, wherein the step of transmitting the encrypted first authentication code further comprises transmitting a first portion of the encrypted first authentication code in at least one of the short messages to the mobile communication device, and transmitting a second portion of the encrypted first authentication code to the client computer via the internet connection.

8. The two-factor authentication system of claim 1, wherein the first, second, and third authentication functions are generated by a Secure Hash algorithm, a Message-Digest algorithm, or a Message Authentication Code algorithm.

9. The two-factor authentication system of claim 8, wherein the transaction server selects from the Secure Hash algorithm, the Message-Digest algorithm, and the Message Authentication Code algorithm, to generate the first, second, and third authentication functions, and the client computer downloads the first, second, and third authentication functions from the transaction server via the internet connection.

10. A two-factor authentication method for securing online transactions between a client computer and a transaction server connected via an internet connection, comprising:
transmitting, performed by the client computer, a transaction request to the transaction server via the internet connection;
applying, performed by the transaction server, a first authentication function to generate a first authentication code;
encrypting, performed by the transaction server, the first authentication code and transmitting the encrypted first authentication code in at least one short message to a mobile communication device;
decrypting, performed by the client computer, the encrypted first authentication code to obtain the first authentication code;
authenticating, performed by the client computer, the transaction server with the first authentication function, the first authentication code, and a user password;
applying, performed by the client computer, a second authentication function to generate a second authentication code and transmitting the second authentication code to the transaction server via the internet connection; and
authenticating, performed by the transaction server, the client computer with the second authentication function, the second authentication code, and the user password.

11. The two-factor authentication method of claim 10, further comprising applying, performed by the client computer, a third authentication function to a transaction message to generate a third authentication code, transmitting, performed by the client computer, the transaction message and the third authentication code to the transaction server via the internet connection, and authenticating, performed by the transaction server, the client computer with the third authentication function, the third authentication code, and the user password.

12. The two-factor authentication method of claim 10, further comprising registering, performed by the client computer, a user identification, the user password, and a SIM card number of the mobile communication device to the transaction server before transmitting the transaction request, wherein the transaction request comprises the user identification.

13. The two-factor authentication method of claim 12, further comprising transmitting, performed by the transaction server, a confirmation code in another short message to the mobile communication device upon being registered to by the client computer, and responding, performed by the client computer, the confirmation code to the transaction server to confirm the SIM card number.

14. The two-factor authentication method of claim 10, further comprising performing, performed by the transaction server and the client computer, a session key negotiation procedure via the internet connection to generate a shared session key for encrypting and decrypting the first authentication code.

15. The two-factor authentication method of claim 14, wherein the session key negotiation procedure is performed according to a Diffi-Hellman protocol or an SSL-like protocol.

16. The two-factor authentication method of claim 10, wherein the step of transmitting the encrypted first authentication code further comprises transmitting a first portion of the encrypted first authentication code in the short message to the mobile communication device, and transmitting a second portion of the encrypted first authentication code to the client computer via the internet connection

17. The two-factor authentication method of claim 10, wherein the first, second, and third authentication functions are a Secure Hash algorithm, a Message-Digest algorithm, or a Message Authentication Code algorithm.

18. The two-factor authentication method of claim 17, further comprising selecting, performed by the transaction server, from the Secure Hash algorithm, the Message-Digest algorithm, and the Message Authentication Code algorithm, to generate the first, second, and third authentication functions, and downloading, performed by the client computer, the first, second, and third authentication functions from the transaction server via the internet connection.
